(19) United States
(12) Patent Application Publication
(10) Pub. No.: US 2025/0044417 A1
(43) Pub. Date: Feb. 6, 2025

(54) PHASED-GRATING-ANTENNA-ARRAY OPTOELECTRONIC EMITTER IN WHICH EACH OPTICAL ANTENNA HAS A LARGE EMISSION AREA

(71) Applicant: COMMISSARIAT A L'ENERGIE ATOMIQUE ET AUX ENERGIES ALTERNATIVES, Paris (FR)

(72) Inventors: Sylvain GUERBER, Grenoble cedex 09 (FR); Daivid FOWLER, Grenoble cedex 09 (FR); Leopold VIROT, Grenoble cedex 09 (FR)

(73) Assignee: COMMISSARIAT A L'ENERGIE ATOMIQUE ET AUX ENERGIES ALTERNATIVES, Paris (FR)

(21) Appl. No.: 18/718,753

(22) PCT Filed: Dec. 9, 2022
(86) PCT No.: PCT/EP2022/085254

§ 371 Date: Jun. 11, 2024

(30) Foreign Application Priority Data
Dec. 13, 2021 (FR) 2113381

(51) Int. Cl. G01S 7/481; G02B 6/34; G02B 27/00; G02B 27/09; G02F 1/295

(52) U.S. Cl. CPC G01S 7/4814; G01S 7/4817; G01S 7/4818; G02B 6/34; G02B 27/0087; G02B 27/0944; G02F 1/2955

(57) ABSTRACT

The invention relates to an optoelectronic emitter comprising a plurality of optical antennas, each comprising: a laterally emitting guiding structure formed from an injection waveguide and from a lateral diffraction grating configured to extract an optical mode in a horizontal plane; and a vertically emitting guiding structure formed from an emission waveguide configured to receive an optical mode extracted by the diffraction grating, and from a vertical diffraction grating configured to extract to free space an optical mode travelling through the emission waveguide.

### TECHNICAL FIELD

The field of the invention is that of phased-array antenna-type optoelectronic emitters preferably produced on a photonic chip of the photonic-on-silicon type. The invention is notably applicable in the field of LIDAR (Light Detection and Ranging).

### PRIOR ART

Optoelectronic emitters with a phased-array antenna (or OPA—Optical Phased Array) are optoelectronic devices that allow monochromatic light radiation to be directionally emitted in free space. They are notably applicable in the field of detecting and estimating a distance using laser (LIDAR), but also in the field of free space optical communications, holographic screens and medical imaging.

FIG. 1A schematically illustrates the operating principle of such an optoelectronic emitter 1. A laser source 2 emits an optical signal, which is distributed by a power splitter 3 in arms 4 of the optoelectronic emitter 1. Each arm 4 comprises a phase shifter 6, and an elementary emitter 7, also called optical antenna. Each optical antenna 7 emits an optical signal in free space, for example by diffraction, with the optical signals then combining by interference in order to form light radiation. This light radiation has a far-field emission pattern that is notably determined by the relative phase Δγ applied by the phase shifters 6 to the optical signals propagating in the arms 4.

Such optoelectronic emitters can be produced using integrated photonic technology, i.e. its various optical components (waveguides, power splitter, optical antennas, etc.) are produced on and from the same photonic chip. In this respect, FIG. 1B schematically and partially illustrates an example of such an optoelectronic emitter 1 described in the article by Hulme et al., entitled “Fully integrated hybrid silicon two dimensional beam scanner”, Opt. Express 23 (5), 5861-5874 (2015). This optoelectronic emitter 1 comprises a laser source 2, in this case of the III-V type, and is produced on the same photonic chip. It therefore comprises, in addition to the semiconductor laser source 2, the power splitter 3, waveguides, called injection waveguides 5 (forming the arms 4), the phase shifters 6 and the optical antennas 7 located in the arms 4. In this example, the laser source 2 is produced by transferring a III-V material onto the photonic chip (of the SOI type), then structuring the material in order to form the gain medium.

The article by Inoue et al., entitled “Demonstration of a new optical scanner using silicon photonics integrated circuit”, Opt Express 27(3), 2499-2508 (2019), describes an example of an optoelectronic emitter comprising a two-dimensional periodic array of optical antennas each comprising a large emission surface area in free space. More specifically, each optical antenna is formed by an injection waveguide, a vertical emission guiding structure formed by a waveguide that is wider than the injection waveguide and a vertical diffraction grating, and a coupling structure formed by a flared waveguide (taper) and providing the optical coupling between the injection waveguide and the vertical emission guiding structure. Such an optical antenna configuration is notably found in the article by Mekis et al., entitled “A Grating-Coupler-Enabled CMOS Photonics Platform”, IEEE Journal of Selected Topics in Quantum Electronics, Vol. 17, No. 3, pp. 597-608, May-June 2011.

However, a requirement exists for providing an optoelectronic emitter with optical antennas that have a larger emission surface area, so as to reduce the far-field divergence of the emitted light radiation.

### DISCLOSURE OF THE INVENTION

The aim of the invention is to at least partly overcome the disadvantages of the prior art, and more specifically to propose an optoelectronic emitter with a phased-array antenna with optical antennas that have a large emission surface area for light radiation in free space, thus reducing the far-field divergence of the emitted light radiation.

To this end, the subject matter of the invention is an optoelectronic emitter with a phased-array antenna, comprising: a splitter, intended to be coupled to a laser source; a plurality of waveguides, called injection waveguides, coupled to the splitter and extending along a longitudinal axis in a main plane, forming the arms of the optoelectronic emitter, a plurality of phase shifters and optical antennas disposed in the arms.

Each optical antenna comprises: the injection waveguide; and a guiding structure, called vertical emission guiding structure, intended to receive an optical mode originating from the injection waveguide, and formed by a waveguide, called emission waveguide, that is wider than the injection waveguide, and by a vertical diffraction grating, coupled to the emission waveguide and adapted to extract to free space an optical mode flowing through the emission waveguide.

According to the invention, each optical antenna also comprises a guiding structure, called horizontal emission guiding structure, formed by the injection waveguide, and a lateral diffraction grating, coupled to the injection waveguide and adapted to extract, in the main plane and toward the emission waveguide, an optical mode flowing through the injection waveguide.

Some preferred but non-limiting aspects of this optoelectronic emitter are as follows.

The optoelectronic emitter can comprise a coupling structure formed by a graded index medium, located between the horizontal emission guiding structure and the vertical emission guiding structure, and adapted to provide optical coupling between the lateral diffraction grating and the emission waveguide.

The coupling structure can comprise an array of elementary couplers laterally arranged facing the lateral diffraction grating, and has transverse dimensions smaller than a main wavelength of the optical mode emitted by the laser source; or can be formed by a medium with a first refractive index containing openings with transverse dimensions that are smaller than a main wavelength of the optical mode emitted by the laser source and filled with a medium with a second refractive index lower than the first index.

The length l_{sc} of the coupling structure can be less than or equal to its total width W_{tot,sc}.

The emission waveguide and the vertical diffraction grating respectively can have widths w_{ge} and w_{tot,rv} that are at least equal to a total width w_{tot,sc} of the coupling structure.

The optical antennas can be periodically arranged with a pitch Λ_{a,y} along an axis orthogonal to the longitudinal axis of the injection waveguides, with the vertical diffraction grating having a total length, called extraction length l_{tot,rv}, that is greater than or equal to 50% or 80% of the pitch Λ_{a,y}.

The optical antennas can be periodically arranged with a pitch Λ_{a,x} along the longitudinal axis of the injection waveguides, with the vertical diffraction grating having a width w_{tot,rv} that is greater than or equal to 50% or 80% of the pitch Λ_{a,x}.

The lateral diffraction grating can be adapted to extract the optical mode at an emission angle φᵣₗ relative to an axis located in the main plane and orthogonal to the longitudinal axis of the injection waveguide, with the vertical emission guiding structure being arranged along a longitudinal axis parallel to the emission angle φᵣₗ as well as the coupling structure, if applicable.

The length, called extraction length l_{tot,rl}, of the lateral diffraction grating can be greater than a width of the injection waveguide. The width w_{ge} of the emission waveguide can be at least equal to the extraction length k_{tot,rl} of the lateral diffraction grating, and, if applicable, the width w_{sc} of the coupling structure can be at least equal to the extraction length l_{tot,rl}.

The width of the injection waveguide can be less than or equal to 1 μm, and the widths of the emission waveguide and of the vertical diffraction grating respectively can be greater than or equal to 10 μm.

The total length, called total extraction length l_{tot,rv}, of the vertical diffraction grating can be greater than or equal to 10 μm.

The lateral diffraction grating can be formed by periodic indentations produced in the injection waveguide, or can be formed by periodic pads located at a distance from the injection waveguide.

The injection waveguide can have a longitudinal variation of at least one parameter representing its width according to a predefined function p, and the lateral diffraction grating has a longitudinal variation of a pitch Λᵣₗ of an arrangement of periodic structures according to a predefined function q, with the functions p and q being predefined as a function of a predefined far-field target emission profile S_{rl,c}(x) of light radiation extracted by the lateral diffraction grating and of a predefined target emission angle φ_{rl,c}.

The vertical diffraction grating can have a longitudinal variation of at least one dimensional parameter of periodic structures according to a function that is predefined as a function of a predefined far-field target emission profile Srv_{,c}(x) of light radiation extracted by the vertical diffraction grating and of a predefined target emission angle φ_{rv,c}.

The optoelectronic emitter can comprise an SOI-type photonic chip containing the lateral emission guiding structure, the coupling structure, if applicable, and the vertical emission guiding structure.

### BRIEF DESCRIPTION OF THE DRAWINGS

Further aspects, aims, advantages and features of the invention will become more clearly apparent upon reading the following detailed description of preferred embodiments thereof, which are provided by way of a non-limiting example, and with reference to the appended drawings, in which:

FIG. 1A, already described, is a schematic and partial view of an optoelectronic emitter with a phased-array antenna according to an example of the prior art;

FIG. 1B, already described, is a schematic and partial top view of such an optoelectronic emitter produced using integrated photonics technology according to an example of the prior art;

FIG. 2 is a schematic and partial top view of an optoelectronic emitter according to one embodiment, in which the optical antennas are arranged in a two-dimensional periodic array and each have a large emission surface area in free space;

FIGS. 3A and 3B are schematic and partial views, as a top view (FIG. 3A) and as a cross-section (FIG. 3B), of an optical antenna of an optoelectronic emitter according to one embodiment;

FIG. 3C is a schematic and partial top view of an optical antenna of an optoelectronic emitter according to another embodiment, in which the coupling structure and the vertical emission guiding structure are aligned along a longitudinal axis A_{L} defined by the non-zero emission angle φᵣₗ of the lateral diffraction grating;

FIG. 4A is a schematic and partial cross-section of an optical antenna of an optoelectronic emitter according to another embodiment, in which the lateral emission guiding structure, the coupling structure and the vertical emission guiding structure are produced from a thin layer and share the same continuous sub-layer (slab);

FIGS. 4B to 4D are schematic and partial top views of various examples of an injection waveguide of a lateral emission guiding structure of an optical antenna;

FIGS. 5A to 5C are schematic and partial top views of optical antennas illustrating various examples of the coupling structure between the lateral emission guiding structure and the vertical emission guiding structure;

FIG. 6A is a flowchart illustrating steps of a method for dimensioning and manufacturing an optical antenna of an optoelectronic emitter according to one embodiment, in which the lateral emission guiding structure is apodized;

FIG. 6B is a schematic and partial cross-section of an optical antenna of an optoelectronic emitter according to another embodiment, in which the vertical diffraction grating of the vertical emission guiding structure is apodized.

### DETAILED DISCLOSURE OF PARTICULAR EMBODIMENTS

In the figures and throughout the remainder of the description, the same reference signs represent identical or similar elements. In addition, the various elements are not shown to scale so as to promote the clarity of the figures. Moreover, the various embodiments and alternative embodiments are not mutually exclusive and can be combined with one another. Unless otherwise indicated, the terms “substantially”, “approximately”, “of the order of” mean to the nearest 10%, and preferably to the nearest 5%. Moreover, the terms “ranging between . . . and . . . ”, and equivalent terms, mean that the limits are inclusive, unless otherwise indicated.

The invention relates to an optoelectronic emitter with a phased-array antenna, comprising an array of optical antennas. The optical antennas are preferably produced on a photonic chip of the photonic-on-silicon type. The optoelectronic emitter is adapted to emit light radiation with a predefined far-field emission profile, for example a constant or Gaussian profile, oriented at a predefined emission angle, and with minimal divergence, at least in a vertical plane parallel to the optical antennas.

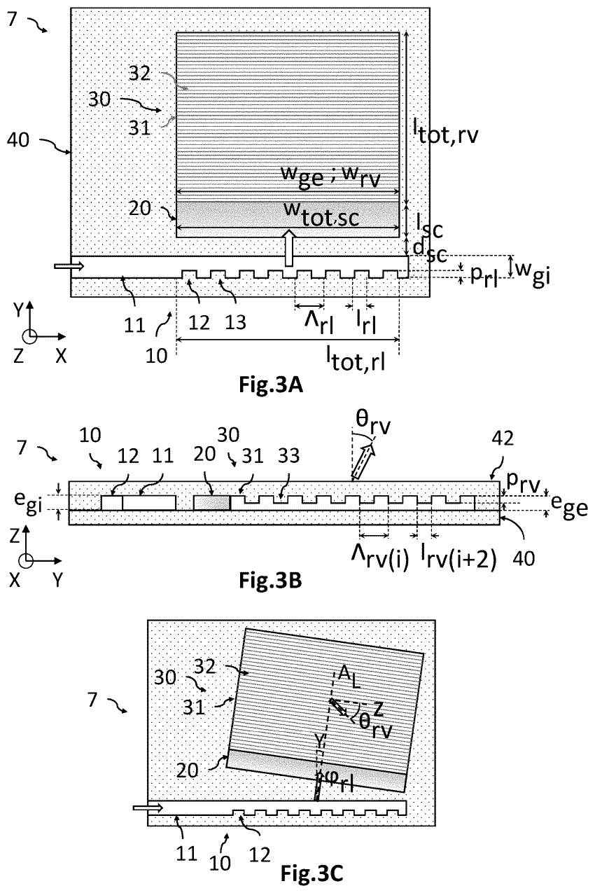

A far-field emission profile is the angular distribution of the intensity of the far-field light radiation emitted by the optoelectronic emitter, about a main axis oriented at the emission angle. The far-field (or Fraunhofer zone) corresponds to a distance D that is greater than the ratio between the square of a large dimension of the optical antenna (for example, its length L_{tot,rl} of the horizontal emission guiding structure: FIG. 3A) to the wavelength λ of the light radiation, and more specifically: D>2L_{tot,rl}²/λ.

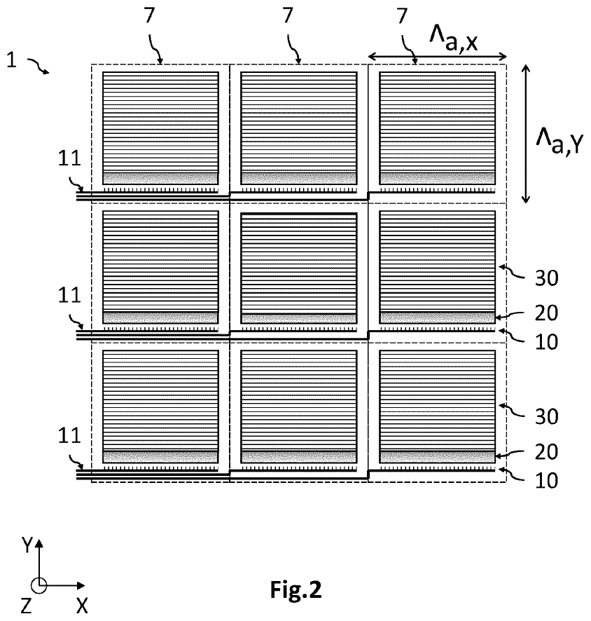

FIG. 2 is a schematic and partial top view of an optoelectronic emitter 1 according to one embodiment. This optoelectronic emitter generally comprises a laser source 2, a power splitter 3 and a plurality of arms 4, comprising phase shifters 6 and optical antennas 7.

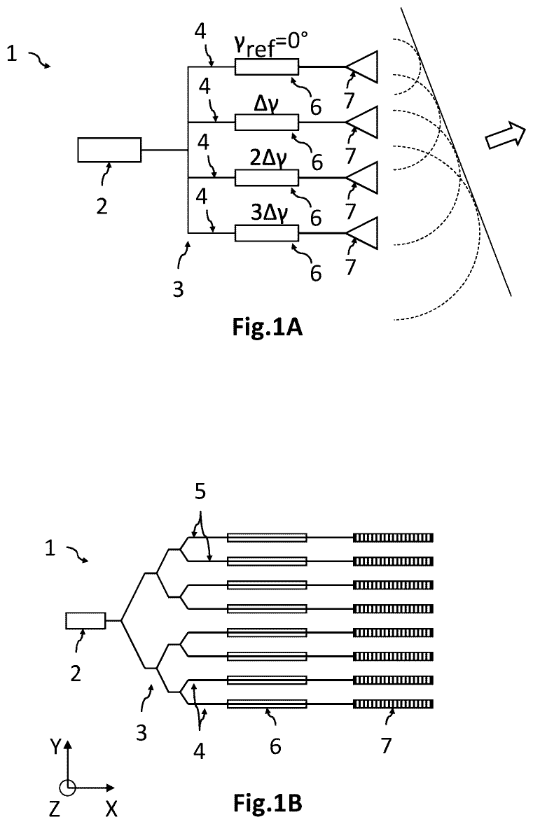

According to the invention, each optical antenna 7 comprises:
a horizontal emission guiding structure 10 (i.e. in the XY plane), formed by a waveguide, called injection waveguide 11 (reference sign ‘5’ in FIG. 1B) and by a lateral diffraction grating 12 adapted to extract an optical mode in the XY plane at an emission angle φᵣₗ relative to the Y axis;
a vertical emission guiding structure 30 (i.e. in a direction substantially parallel to the Z axis), coupled to the vertical emission guiding structure 10, and formed by a waveguide, called emission waveguide 31, and by a vertical diffraction grating 32 adapted to extract an optical mode at an emission angle θᵣᵥ relative to the Z axis.

A direct XYZ orthonormal coordinate system is defined herein and for the remainder of the description, in which the XY plane is parallel to the plane of the photonic chip, with the X axis being oriented along the longitudinal axis of the horizontal emission guiding structures 10 of the optical antennas 7, and in which the Z axis is oriented toward the free space in which the light radiation is emitted by the optoelectronic emitter 1. The terms “lower” and “upper” relate to a distance from a support substrate in the +Z direction.

In this embodiment, the optoelectronic emitter 1 is integrated on a photonic chip, for example within the context of ‘photonic-on-silicon’ technology. The photonic chip, also called photonic integrated circuit (PIC), comprises a support substrate, from which active (modulators, diodes, etc.) and passive (waveguides, multiplexers or demultiplexers, etc.) photonic components can be produced that are optically coupled to one another. Within the context of photonic-on-silicon technology, the support substrate and the photonic components are made from silicon. The photonic chip thus can be of the SOI (Silicon On Insulator) type. Thus, in this example, the structures 10, 20, 30 are made of silicon. However, many other technological platforms can be used according to the targeted applications and the wavelength of the light radiation. Thus, it is possible to produce the waveguides, for example, from silicon nitride (SiN), aluminum nitride (AlN), doped silica, etc.

The optoelectronic emitter 1 comprises a laser source 2 adapted to emit a pulsed or continuous monochromatic optical signal, of wavelength λ. The wavelength can be, by way of an illustration, equal to 1,550 nm. The laser source 2 can be wavelength tunable, notably in order to modify the emission angle θᵣᵥ formed by the light radiation emitted by the optical antennas 7 relative to the vertical Z axis in the YZ plane, or in an A_{L}Z plane parallel to the vertical Z axis and to the longitudinal axis A_{L} (see FIG. 3C). A modification of the wavelength would also induce a variation in the angle φᵣₗ. The laser source 2 can be a hybrid source formed by a gain medium produced from a III/V compound and bonded to the surface of the photonic chip. Optical reflectors of the Bragg mirror type thus can be produced in an integrated waveguide and coupled to the gain medium. As an alternative embodiment, the photonic chip may not comprise the laser source 2, with the laser source then being remote and therefore not assembled on the surface of the photonic chip. It then can be coupled to an integrated waveguide of the photonic chip, notably by a grating coupler.

A power splitter 3 is coupled to the output of the laser source 2. It thus comprises an input and a plurality of outputs each coupled to a waveguide of the optoelectronic emitter 1. The number of waveguides, called injection waveguides 11, corresponds to the numbers of arms 4 of the optoelectronic emitter 1. In this example, the power splitter 3 is formed by several MMI (Multimode Interferometer) type splitters arranged in a cascade like manner, but other types of optical components can be used (for example, directional couplers, Y junctions, star couplers, etc.).

The optoelectronic emitter 1 comprises a plurality of injection waveguides 11 that extend between a first end coupled to one of the outputs of the power splitter 3 and an opposite second end, and which form the arms 4 of the optoelectronic emitter 1. Each injection waveguide 11 is therefore adapted to receive an optical signal originating from the power splitter 3, and to allow this optical signal to propagate up to an optical antenna 7.

The optoelectronic emitter 1 also comprises a plurality of phase shifters 6 disposed in the arms 4. More specifically, an injection waveguide 11 is coupled to at least one phase shifter 6 adapted to modify the phase of the optical signal flowing through the considered injection waveguide 11, and to thus generate a phase difference Δγ, or relative phase, between the optical modes flowing through the adjacent injection waveguides 11. The phase shifters 6 are disposed between the power splitter 3 and the optical antennas 7. Each injection waveguide 11 can be equipped with a phase shifter, or only some of the injection waveguides 11 can be equipped with a phase shifter, such as, for example, one in two injection waveguides 11. In addition, a reference injection waveguide 11 may not comprise a phase shifter.

The phase shifters 6 can be electro-refractive effect phase shifters or thermo-optical effect phase shifters. In both cases, the phase is modified by modifying the refractive index n_{gi} of the considered injection waveguide 11. This modification of the refractive index can be obtained by modifying the free carrier density in the case of the electro-refractive phase shifter, or by modifying the applied temperature in the case of the thermo-optical phase shifter.

The phase shifters 6 are adapted to apply a predefined phase value Δγ relative to the optical modes propagating in the injection waveguides 11, so as to obtain a determined non-zero angle of the main emission axis relative to the vertical Z axis in the YZ plane or in the A_{L}Z plane. However, the relative phase Δγ may not be identical between the injection waveguides 11, either to obtain a different far-field emission profile, or to take into account and compensate for possible phase errors. These phase errors can originate from the degradation of some components of the optoelectronic emitter 1 over time, from non-uniformities during the manufacturing method, from non-zero tolerances of the manufacturing method, from the environmental impact of the optoelectronic emitter 1 (for example, the possible effect of the packaging elements covering the elementary emitters).

The phase shifters 6 are preferably connected to a control module (not shown). Depending on the control signals sent by the control module, the phase shifters 6 can generate a predetermined relative phase Δγ in the optical signals flowing through the various injection waveguides 11. An example of such a control module is described in the article by Hulme et al., entitled “Fully Integrated hybrid silicon two dimensional beam scanner”, Opt. Express 23 (5), 5861-5874 (2015), or in document WO 2021/130149 A1.

The optoelectronic emitter 1 comprises a plurality of optical antennas 7 disposed downstream of the phase shifters 6, in this case one optical antenna 7 per arm 4. The relative phase Δγ between the optical signals emitted by the optical antennas 7 notably determines the value of the angle formed by the main emission axis of the far-field light beam relative to the vertical Z axis in the YZ plane or in the A_{L}Z plane of the optoelectronic emitter 1.

The optical antennas 7 are identical to one another. They are laterally arranged along the X and Y axes (see FIG. 2). They are spaced apart from one another by a distance that preferably ranges between λ/2 and 2λ, where λ is the main wavelength of the optical mode emitted by the laser source 2. For information purposes, the number of optical antennas 7 can range from around ten to around ten thousand, so as to limit the divergence of the far-field light radiation along the X and Y axes.

The optical antennas 7 in this case are periodically arranged along at least one main axis, and in this case along the X and Y axes, with a pitch Λ_{a,x} and a pitch Λ_{a,y} that are preferably of the same order of magnitude so as to make the far-field emission profile of the emitted light radiation symmetrical around the emission axis. As described hereafter, the emission surface area of each optical antenna preferably has dimensions lᵣᵥ, w_{tot,rv} that are respectively greater than or equal to 50%, preferably to 70%, and more preferably to 80%, of the pitch Λ_{a,y} and Λ_{a,x}, so as to reduce the intensity of the secondary lobes of the far-field emission profile of the optoelectronic emitter 1.

FIGS. 3A and 3B are schematic and partial views of an optical antenna 7 of an optoelectronic emitter according to one embodiment, as a top view (FIG. 3A) and as a cross-section (FIG. 3B).

To this end, each optical antenna 7 therefore comprises: a horizontal emission guiding structure 10, adapted to extract the optical mode flowing through the injection waveguide 11 and to emit it in the XY plane toward a vertical emission guiding structure 30; and the vertical emission guiding structure 30 is adapted to receive the light radiation emitted by the guiding structure 10 and to emit it in free space in the YZ plane or in the A_{L}Z plane. Each guiding structure 10, 30 comprises a waveguide and a diffraction grating.

In this example, each optical antenna 7 further comprises a graded index coupling structure 20, which optimizes the optical coupling between the two guiding structures 10, 30. This coupling structure is optional but advantageous since it improves the performance capabilities of the optoelectronic emitter 1.

FIG. 3C is a schematic and partial top view of an optical antenna 7 according to another embodiment. In this example, the coupling structure 20 and the vertical emission guiding structure 30 are oriented in the XY plane as a function of the emission angle φᵣₗ of the lateral emission guiding structure 10. Thus, the coupling structure 20 and the vertical emission guiding structure 30 extend along a longitudinal axis A_{L}, which forms an angle equal to φᵣₗ relative to the Y axis. It should be noted in this case that the emission angle θᵣᵥ of the guiding structure 30 is defined relative to the vertical Z axis, and that it is contained in an A_{L}Z plane passing through the longitudinal axis A_{L} and through the vertical Z axis. However, for the sake of clarity, it should be noted that the far-field emission profile Sᵣᵥ(y) of the vertical emission guiding structure 30, as well as the emission angle θᵣᵥ(y), depend on the abscissa y, while they more specifically depend on an abscissa defined along the longitudinal axis A_{L}.

It should be noted in this case that the value of the angle φᵣₗ is set by the pitch Λᵣₗ of the lateral diffraction grating 11, and that the value of the emission angle θᵣᵥ of each optical antenna 7 is set by the pitch Λᵣᵥ of the vertical diffraction grating 31 (and not by the phase shift Δγ between the optical antennas 7). These two parameters control the direction of emission of the envelope formed by the radiation emitted by the optical antennas 7. The phase shift Δγ between the optical antennas 7 for its part allows the beam emitted by the optoelectronic emitter 1 to be directed (resulting from the interference of the beams emitted by the optical antennas 7), which is necessarily located within the envelope of the optical antennas 7. In this example, the emission angle of the optoelectronic emitter 1 will actually be close to the emission angle θᵣᵥ of the optical antennas 7 insofar as the envelope of the antennas is very narrow (due to the large emission surface area of the optical antennas 7).

The optical antennas 7 in this case are made in a photonic chip, in this case using photonic-on-silicon technology. This chip is formed by a support substrate (not shown), in this case made of silicon, a lower layer 40 of buried oxide (BOX), which helps form the cladding of the waveguides, and diffraction gratings produced in a silicon layer, and an upper layer 42 made of a silicon oxide and which helps form the cladding. In the example of FIG. 3B, the lateral emission guiding structure 10 and the coupling structure 20 are physically distinct, and are therefore separated in the XY plane, in this case by the silicon oxide that helps to define the cladding of the waveguides.

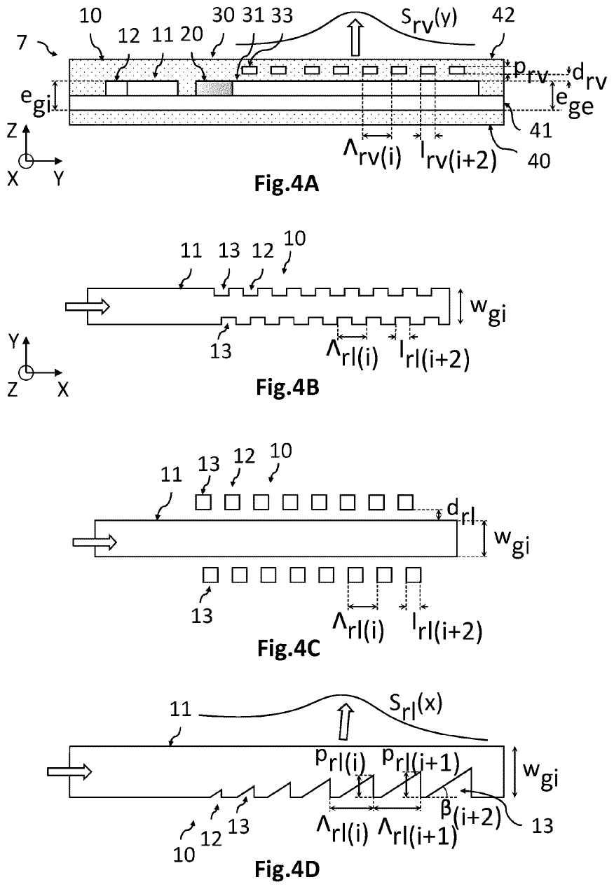

FIG. 4A is a schematic and partial cross-section of an optical antenna 7 according to another embodiment, in which the guiding structures 10, 30 and the coupling structure 20 comprise a continuous lower sub-layer 41 common to the three structures 10, 20, 30, called base or slab, surmounted by an upper sub-layer called rib, structured so as to define the structures. The base 41 can thus improve the optical coupling, notably between the lateral emission guiding structure 10 and the coupling structure 20.

The lateral emission guiding structure 10 is therefore adapted to receive the optical mode emitted by the laser source 2 and to extract it in the XY plane toward the coupling structure 20. To this end, it comprises the injection waveguide 11 and a lateral diffraction grating 12. It has a basically one-dimensional, or linear, configuration in the XY plane, in the sense that its width is significantly smaller than its extraction length, for example at least 10 times or even at least 100 times smaller.

By way of an example, its width (width w_{gi} of the injection waveguide 11) can be less than or equal to 1 μm, for example of the order of 0.5 μm, compared with the extraction length l_{tot,rl} (length of the lateral diffraction grating 12), which is at least equal to 10 μm, for example of the order of 60 μm or even more (100 μm or even more). Moreover, the extraction length, which is defined as being the length l_{tot,rl} of the lateral diffraction grating, is less than or equal to, and in this case is of the order of magnitude of, the width w_{ge} of the inlet face of the emission waveguide 31 of the vertical emission guiding structure 30.

The injection waveguide 11 is that which transmits the optical mode from the power splitter 3. It is defined by physical parameters, such as the refractive index n_{gi} of the waveguide (i.e. of the core of the waveguide), the refractive index n_{gg} of the cladding, and the transverse dimensions of thickness e_{gi} along the Z axis and of width w_{gi} along the Y axis. Preferably, the thickness e_{gi} remains constant along the longitudinal axis X, and the width w_{gi} can maintain a constant value. As an alternative embodiment, as described hereafter, the width w_{gi} can vary along the longitudinal axis X, for example between an upstream maximum value and a downstream minimum value, in particular so that the far-field emission profile Sᵣₗ(x) of the extracted light radiation has a predefined target profile S_{rl,c}(x).

The lateral diffraction grating 12 is adapted to extract the optical mode flowing through the injection waveguide 11 toward the coupling structure 20 in the XY plane. The optical mode is extracted in the XY plane according to a far-field emission profile Sᵣₗ(x), at an emission angle φᵣₗ(x). Preferably, the emission profile Sᵣₗ(x) is equal to a target profile S_{rl,c}(x), and the emission angle φᵣₗ(x) is constant and equal to a target value φ_{rl,c}. The target value is predefined relative to a Y axis orthogonal to the longitudinal axis X. The lateral diffraction grating 12 preferably extends over a sufficient length to extract almost all or all of the optical mode. This extraction length is the dimension l_{tot,rl} of the lateral diffraction grating 12, which preferably is less than the total width w_{tot,sc} of the coupling structure 20.

The lateral diffraction grating 12 can be produced in the injection waveguide 11, for example in the form of indentations, or can be produced at a distance from the injection waveguide, for example in the form of pads with a high refractive index surrounded by the cladding with a low refractive index. It therefore comprises periodic structures 13 (indentations or pads) arranged along the injection waveguide 11 along the longitudinal axis X.

It is defined by physical parameters representing the diffraction (and therefore the extraction) of the optical mode flowing through the injection waveguide 11. It particularly involves the arrangement pitch Λᵣₗ, the dimensions of length lᵣₗ along the X axis and of depth or width pᵣₗ along the Y axis, the fill factor ffᵣₗ=lᵣₗ/Λᵣₗ, of the refractive indices of the materials used, and optionally their spacing dᵣₗ (see FIG. 4C) relative to the injection waveguide 11.

When the lateral emission guiding structure 10 does not comprise a base 41, the periodic structures 13 can be produced in the form of an indentation over the entire thickness of the injection waveguide 11. In addition, when it comprises a base 41, they can only be produced over the thickness of the rib. Moreover, they can be located on one side and/or the other side of the injection waveguide 11 along the Y axis. In this case, they are not located facing the injection waveguide 11 along the vertical Z axis. In this respect, FIGS. 3A and 3C illustrate an example of a lateral diffraction grating 12, in which the periodic structures 13 in this case are indentations in the form of a slot (rectangular indentations) produced in the injection waveguide 11, in this case located on the side opposite the coupling structure 20.

FIG. 4B is a schematic and partial top view of another example of a lateral diffraction grating 12, in which the periodic structures 13 are formed by indentations in the form of rectangular slots produced in the injection waveguide 11, and are located in the two opposite sides of the injection waveguide 11, and in this case are arranged asymmetrically along the X axis.

FIG. 4C is a schematic and partial top view of another example of a lateral diffraction grating 12, in which the periodic structures 13 are formed by pads located at a distance do from the injection waveguide 11. The pads are made of a material with a high refractive index, for example in this case from silicon or from a silicon nitride, and are surrounded by a material with a low refractive index, in this case from a silicon oxide. They are located facing the two sides of the injection waveguide 11. As an alternative embodiment, the pads can only be located facing one side or the other side of the injection waveguide 11. In this case, they are asymmetrically arranged along the longitudinal axis X. In this case, they are located at a non-zero distance dᵣₗ from the injection waveguide, and are therefore spaced apart from the injection waveguide by the silicon oxide. They could be located at a zero distance dᵣₗ and therefore could be joined to the injection waveguide 11. The distance dᵣₗ is defined as the distance between the faces facing the periodic pads and the waveguide. It should be noted that, in these examples, the lateral diffraction grating 12 only impacts the evanescent part of the optical mode, which allows the value of the extraction rate to be reduced and therefore allows the extraction length l_{tot,rl} to be increased.

FIG. 4D is a schematic and partial top view of another example of a lateral diffraction grating 12, in which the periodic structures 13 are indentations produced in the injection waveguide 11 and are triangular. They are located on the opposite side to the coupling structure 20. They are also defined in this case by an angle R formed by the hypotenuse of the triangle (in this case a right-angled triangle) relative to the longitudinal axis X. Of course, the triangular shape in this case is shown schematically, and, in reality, it can be slightly different (notably at the corners) due to the technological production constraints. The grating in this case is a blazed grating (echelette grating) and the angle β is the blaze angle. This angle is selected so that the grating operates in reflection (total internal reflection regime) and can be equal to 30°, for example.

It should be noted in this case that, in general, a diffraction grating has an extraction rate α for the optical mode flowing through the waveguide, with this rate sometimes being called emission strength or scattering strength. As indicated in the article by Zhao et al., entitled “Design principles of apodized grating couplers”, Journal of Lightware Technology, Vol. 38, No. 16, pp. 4435-4446, 2020, the extracted local optical power, which defines the emission profile S(x), depends on the local power of the optical mode P(x) (or, if applicable, that of the evanescent part) and of the extraction strength α(x) via the following relationship: S(x)˜α(x)×P(x).

As will be described hereafter, the injection waveguide 11 and the lateral diffraction grating 12 preferably can have dimensional parameters that vary longitudinally according to predefined functions, so that the far-field emission profile Sᵣₗ(x) is equal to a predefined target profile S_{rl,c}(x), and is oriented at an emission angle φᵣₗ(x) that is equal to a constant target value φ_{rl,c} along the longitudinal axis X. These dimensional parameters can be the depth pᵣₗ and/or the width w_{gi}, and the pitch Λᵣₗ of the lateral diffraction grating 12.

The optical antenna 7 also comprises a coupling structure 20 adapted to provide the optical coupling between the lateral emission guiding structure 10 and the vertical emission guiding structure 30. It is therefore located between the two guiding structures 10, 30. Insofar as the extraction length l_{tot,rl} of the lateral diffraction grating is of the same order of magnitude as the width w_{ge} of the emission waveguide 31, the coupling structure 20 does not have to adapt the spatial distribution of the optical mode in the XY plane, but basically has to adapt the mean refractive index (and therefore the effective index of the optical mode) between a minimum value close to that of the cladding and the maximum value equal to the refractive index of the emission waveguide 31.

It should be noted in this case that, in general, the effective index n_{eff} associated with an optical mode supported by a waveguide is defined as the product of the propagation constant β and of λ/2π. The propagation constant β depends on the wavelength λ of the optical mode, as well as on the properties of the waveguide or, in this case, on the coupling structure (refractive indices and transverse dimensions of the core and of the cladding). The effective index n_{eff} of the optical mode corresponds, to a certain extent, to the refractive index of the waveguide ‘seen’ by the optical mode. It usually lies between the refractive index of the waveguide and the refractive index of the cladding.

The coupling structure 20 is thus a graded index optical structure, allowing the effective index of the optical mode to be adapted that is thus transferred between the injection waveguide 11 and the emission waveguide 31. It has patterns that are smaller than the wavelength of the transferred optical mode, and it is thus a sub-wavelength grating graded index structure (SWG GRIN). It is formed, for example, by at least two materials with different refractive indices, arranged so that the mean refractive index monotonously varies along the longitudinal axis A_{L} from its upstream face (oriented toward the lateral diffraction grating 12) toward its downstream face (oriented toward the emission waveguide 31). The mean index can be invariant along its width, i.e. along an axis orthogonal to the longitudinal axis A_{L} and contained in the XY plane. It can be defined on any abscissa of the longitudinal axis A_{L} as, for the first order, an average of the refractive indices of the materials of the coupling structure over the entire total width w_{tot,sc} of the coupling structure 20 for the considered abscissa.

The coupling structure 20 has a total width w_{tot,sc} along an axis orthogonal to the axis A_{L} and a length l_{tot,sc}, in this case along the axis A_{L}, and, in this example, the length l_{tot,sc} is less than its total width w_{tot,sc}, and allows the lateral diffraction grating 12 to be effectively coupled to the emission waveguide 31 over a limited coupling length. This thus avoids having to use a taper providing the coupling between the injection waveguide 11 and the emission waveguide 31, as in the aforementioned examples of the prior art, which allows the coupling length between the guiding structures 10 and 30 to be significantly reduced, and therefore allows the free space emission surface area of the optical antenna 7 to be increased.

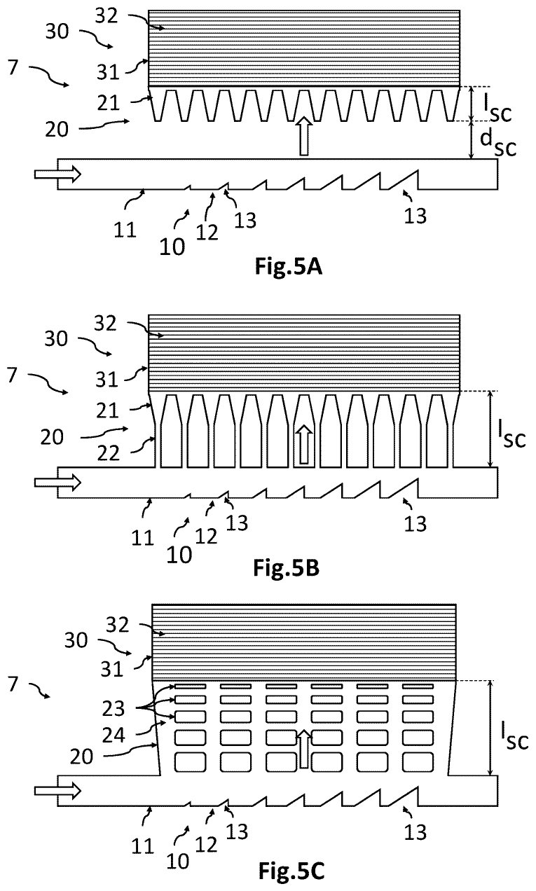

FIG. 5A is a schematic and partial view of an optical antenna 7 with a coupling structure 20 according to a first example. In this case, the coupling structure 20 is formed by an array of elementary couplers 21 as a trapezium or as a tip with sub-wavelength dimensions, of the taper type. They are produced as a single piece with the emission waveguide 31. The elementary couplers 21 are laterally distributed along a pitch Λ_{sc}, in this case of approximately 250 nm, have an upstream width of approximately 50 nm and a downstream width of approximately 200 nm, and a length l_{sc} of approximately 500 nm. In this case, they are spaced apart from the injection waveguide 11 by a distance d_{sc} of approximately 500 nm.

FIG. 5B is a schematic and partial view of an optical antenna 7 with a coupling structure 20 according to another example. The coupling structure 20 in this case differs from that of FIG. 5A basically in that the elementary couplers 21 are directly connected to the injection waveguide 11 by narrow waveguides 22 with a width of approximately 50 nm. In addition, the coupling structure 20 is spaced apart by a zero distance d_{sc} from the injection waveguide 11.

FIG. 5C is a schematic and partial view of an optical antenna 7 with a coupling structure 20 according to another example. In this case, the coupling structure 20 is formed by a portion of a layer of high-index material, in this case silicon, directly connecting the injection waveguide 11 to the emission waveguide 31, and having a two-dimensional array of openings 23 with sub-wavelength dimensions filled with a medium with a low refractive index (silicon oxide) produced in a continuous medium 24 with a high refractive index (silicon).

The vertical emission guiding structure 30 comprises a waveguide, called emission waveguide 31, that is wider than the injection waveguide 11, and a vertical diffraction grating 32. The emission waveguide 31 is adapted to receive an optical mode transmitted by the coupling structure 20 and that has been extracted from the injection waveguide 11 by the lateral diffraction grating 12. The vertical diffraction grating 32 is adapted to extract the optical mode flowing through the emission waveguide 31 and to emit it in free space in an emission direction θᵣᵥ.

It preferably has a basically two-dimensional configuration in the XY plane, in the sense that its width is the same order of magnitude as its extraction length, and can be greater than or equal to 10 μm, for example of the order of 60 μm. In any case, the width w_{ge} of the emission waveguide 31 is much greater, for example 100 times greater, than the width w_{gi} of the injection waveguide 11. The emission surface area in this case is the product of the total width w_{tot,rv} and of the total length l_{tot,rv} of the vertical diffraction grating 32, that is of the order of 60 μm×60 μm in this example.

The emission waveguide 31 receives the light radiation originating from the injection waveguide 11, extracted by the lateral diffraction grating 12, and transmitted by the coupling structure 20. It is defined by physical parameters such as the refractive index n_{ge} of the waveguide (i.e. of the core of the waveguide), the refractive index n_{gg} of the cladding, and the transverse dimensions of thickness e_{ga} along the Z axis, and of width w_{ge} along an axis orthogonal to the axis A_{L}.

Thus, the emission waveguide 31 differs from the injection waveguide 11 by its width w_{ge}, which is much greater than the width w_{gi}, for example 100 times greater. In addition, its longitudinal axis A_{L} is not coplanar with the longitudinal axis X of the injection waveguide 11, but is substantially orthogonal thereto to the nearest emission angle φᵣₗ.

The vertical diffraction grating 32 is adapted to extract the optical mode flowing through the emission waveguide 31 in the free space. The optical mode is extracted in the A_{L}Z plane according to a far-field emission profile Sᵣᵥ(y), at an emission angle θᵣᵥ(y). Preferably, the emission profile Sᵣᵥ(y) is equal to a target profile S_{rv,c}(y), and the emission angle θᵣᵥ(y) is constant. Moreover, the vertical diffraction grating 32 preferably extends over a sufficient length to extract almost all or all of the optical mode. This extraction length is the dimension l_{tot,rv} of the vertical diffraction grating 32.

The vertical diffraction grating 32 is located above the emission waveguide 31, and can be produced either in the emission waveguide 32 or at a distance dr (zero or non-zero) therefrom. In addition, the thickness e_{ge} is defined as the maximum value along the Z axis. Moreover, the width w_{ge} can remain constant or can vary along the longitudinal axis A_{L}, so that the emission profile S_{yz}(y) of the extracted light radiation has a predefined target profile.

To this end, the vertical diffraction grating 32 comprises periodic structures 33 arranged along the emission waveguide 31. It is thus defined by physical parameters representing the diffraction (and therefore the extraction) of the optical mode flowing through the emission waveguide 32. It particularly involves the arrangement pitch Λᵣᵥ, the length lᵣᵥ dimensions along the longitudinal axis A_{L}, the height or the depth pᵣᵥ, the fill factor ffᵣᵥ=lᵣᵥ/Λᵣᵥ, and the refractive indices of the materials used, and optionally their spacing dᵣᵥ relative to the emission waveguide 31. In order to obtain the desired target emission profile, at least one dimensional parameter has a predefined longitudinal variation, for example the fill factor ffᵣᵥ, and the pitch Λᵣᵥ can also have a predefined longitudinal variation in order to keep the emission angle θᵣᵥ constant (in order to compensate for the variation in the effective index associated with the variation in the fill factor ffᵣᵥ).

FIG. 3B is a schematic and partial cross-section of an example of a vertical diffraction grating 32, in which the periodic structures 33 are indentations in the form of a rectangular slot produced in the emission waveguide 31, from its upper face. Of course, the indentations can assume shapes other than the rectangular shape.

FIG. 4A is a schematic and partial cross-section of another example of a vertical diffraction grating 32, in which the periodic structures 33 are pads with a high refractive index (for example, silicon or silicon nitride) surrounded by the cladding made of silicon oxide. The pads are located at a distance dᵣᵥ from the emission waveguide 31, which can be non-zero, as in this case, or zero (with the pads then being joined to the emission waveguide 31). It should be noted that, in this example, the vertical diffraction grating 32 only impacts the evanescent part of the optical mode, which allows the value of the extraction rate to be reduced and therefore allows the extraction length to be increased.

Thus, the optical signals flowing through the injection waveguides 11 are extracted by the lateral diffraction gratings 12, and are then transmitted to the emission waveguide 31 by the coupling structure 20, in order to be subsequently extracted and emitted in free space by the vertical diffraction gratings 32. Thus, the emitted light radiation propagates in free space, recombines by interference, and thus forms, in the far-field, the light radiation that is emitted by the optoelectronic emitter 1 for which the angular distribution around the main emission axis is determined and defines the far-field emission profile of the optoelectronic emitter 1.

Thus, the optoelectronic emitter 1 can then emit far-field light radiation with minimal divergence, at least in the YZ or A_{L}Z plane, and in this case also in the XZ plane. This is due to the fact that each optical antenna 7 has a large emission surface area, due to the fact that the optical coupling between the injection waveguide 11 and the vertical emission guiding structure 30 is carried out laterally by means of a lateral diffraction grating 12 and of a graded index coupling structure 20, and not horizontally by means of a taper, as in the aforementioned examples of the prior art.

The fact that the emission surface area can be increased for unchanged pitch values Λ_{a,x} and Λ_{a,y} of the optical antennas 7 notably allows the intensity radiated in secondary lobes of the far-field emission profile of the light radiation emitted by the optoelectronic emitter 1 to be reduced. Thus, in the event that the emission angle θᵣᵥ is low, i.e. of the order of a few degrees, for example less than or equal to 15° or even less, a width w_{tot,rv} of the vertical diffraction grating 32 (which corresponds to the width of the emission surface area) of the order of at least 50%, and preferably of at least 80%, of the pitch Λ_{a,x} allows the secondary lobes of the far-field emission profile of the light radiation emitted in the XZ plane to be reduced or even eliminated. Similarly, a total length l_{tot,rv} of the vertical diffraction grating 32 (which corresponds to the length of the emission surface area) of the order of at least 50%, and preferably of at least 80% of the pitch Λ_{a,y} allows the secondary lobes of the far-field emission profile of the light radiation emitted in the YZ plane to be reduced or even eliminated. Finally, it should be noted in this case that increasing the number of optical antennas 7 allows the directivity of the emitted light radiation to be increased, i.e. allows the mid-height width of the far-field emission profile to be reduced.

Furthermore, the far-field emission profile of each optical antenna 7 can be equal to a predefined target profile and oriented at an emission angle θᵣᵥ that is equal to a predefined target value. This can be obtained by the fact that the lateral emission guiding structure 10 and/or the vertical emission guiding structure 30 can be apodized, i.e. can have dimensional parameters that vary longitudinally according to predefined functions. Thus, the local value of the extraction rate αᵣₗ can be easily adjusted by means of the width w_{gi} of the injection waveguide 11, unlike the apodization that can be carried out in the prior art where the originators only modify the dimensions of the periodic structures, as shown, for example, in the article by Mekis et al., entitled “A Grating-Coupler-Enabled CMOS Photonics Platform”, IEEE Journal of Selected Topics in Quantum Electronics, Vol. 17, No. 3, pp. 597-608, May-June 2011. Finally, longitudinally varying the width w_{gi} of the injection waveguide 11 and at least the pitch Λᵣₗ of the lateral diffraction grating 12, limits the constraints of dimensioning the periodic structures that could result in particularly small dimensions and therefore could be hardly or even not compatible with the conventional technologies normally used in the manufacturing methods, for example photonic-on-silicon technologies.

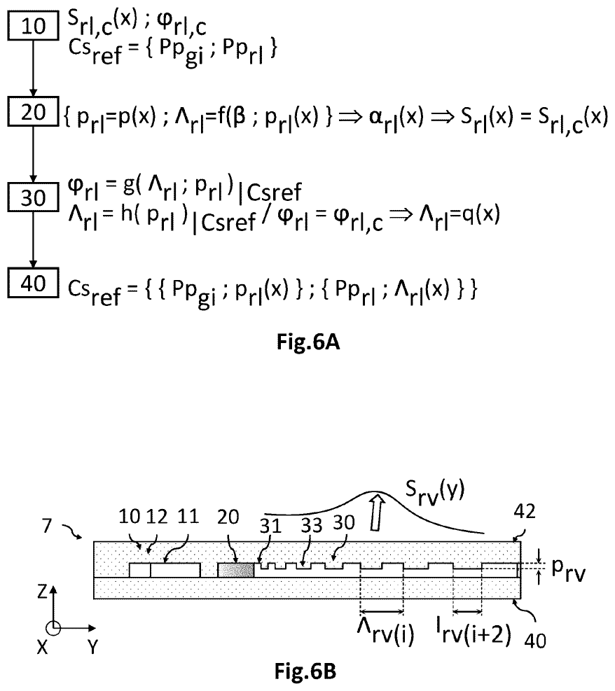

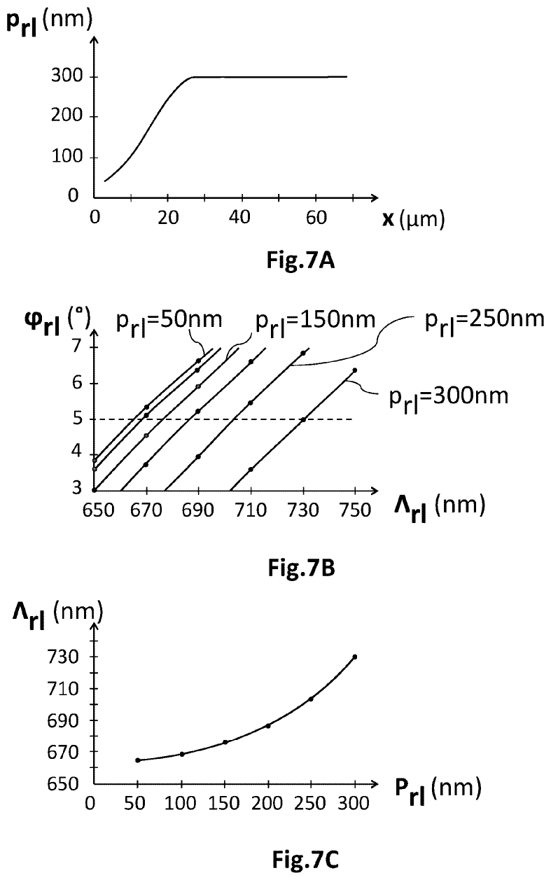

FIG. 6A is a flowchart of a method for dimensioning the lateral emission guiding structure 10 and for manufacturing the corresponding optical antenna 7 of the optoelectronic emitter 1, according to one embodiment. The injection waveguide 11 and the lateral diffraction grating 12 of the guiding structure 10 have dimensional parameters that vary along the longitudinal axis X, so that the emission profile Sᵣₗ(x) is equal to a predefined target profile S_{rl,c}(x), and so that the emission angle φᵣₗ(x) is constant and equal to a predefined target angle φ_{rl,c}(x). Reference is thus made to apodization of the injection waveguide 11 and of the lateral diffraction grating 12, which can involve the entire length of the guide 11 (in the corresponding antenna) and of the grating 12, or only part of the length.

In this example, the lateral diffraction grating 12 is formed by triangular indentations produced in the injection waveguide 11, as shown in FIG. 4D. The indentations have a longitudinal variation pᵣₗ=p(x) of the depth pᵣₗ according to a predefined function p, in this case an increasing function, such that the far-field emission profile Sᵣₗ(x) is equal to a target profile S_{rl,c}(x). However, this longitudinal variation of the depth pᵣₗ of the indentations results in a longitudinal variation of the minimum width w_{gi,min}(x), defined as the difference between the width w_{gi} and the value pᵣₗ. This longitudinal variation of the minimum width w_{gi,min}(x) of the injection waveguide 11 results in a variation in the effective index of the optical mode. However, the emission angle θᵣₗ(x) depends on the local value of the effective index, according to the following equation:

$$sin θ ( x ) = \frac{{n}_{eff} ( x ) + m \frac{λ}{Λ}}{{n}_{c}} \qquad [ Math 1 ]$$

where m is the diffraction order.

It therefore appears that, in order to keep the emission angle φᵣₗ(x) equal to the target value φ_{rl,c} and constant along the longitudinal axis X, it is important to also define a longitudinal variation of a dimensional parameter of the lateral diffraction grating 12, for example a longitudinal variation Λᵣₗ=q(x) of the pitch Λᵣₗ according to a predefined function q. The dimensional parameters of each period can be noted using an index i varying from 1 to M, where M is the number of periods of the lateral diffraction grating in the apodized part. This then provides the pitch Λᵣₗ(i) and the depth pᵣₗ(i) for the period of index i.

In this example, the lateral emission guiding structure 10 has, on the one hand, a longitudinal variation pᵣₗ=p(x) of the depth pi of the indentations, which represents a longitudinal variation of the minimum width w_{gi,min} of the injection waveguide 11, and, on the other hand, a longitudinal variation Λᵣₗ=q(x) of the pitch of the lateral diffraction grating 12. The functions p and q are predefined so that the far-field emission profile Sᵣₗ(x) oriented at the emission angle φᵣₗ is equal to the target profile S_{rl,c} oriented at the angle φ_{rl,c}.

During a step 10, the target far-field emission profile S_{rl,c}(x) of the light radiation to be emitted by the guiding structure 10 of each optical antenna 7 is defined, as is the target emission angle φ_{rl,c}. By way of an example, the emission profile S_{rl,c}(x) is Gaussian. Moreover, the target emission angle φ_{rl,c} is constant for any value x of the longitudinal axis X, and in this case is equal to 5°. In this case, the optical mode is considered to have a wavelength λ that is equal to 1,550 nm, for example.

In addition, the same reference structural configuration Cs_{ref} is defined for the guiding structures 10. This structural configuration Cs_{ref} includes the values of the physical parameters Pp_{gi} of the injection waveguide 11 that define the optical transmission properties of the optical mode by the injection waveguide 11, namely the refractive indices n_{gi} and n_{gg} of the injection waveguide 11 and of the cladding, and the thickness e_{gi} of the waveguide, so that: Pp_{gi}={n_{gi}, n_{gg}, e_{gi}}. By way of an example, the injection waveguide 11 can be made of silicon and have a refractive index n_{gi} of 3.48, and the cladding can be made of SiO₂ and have a refractive index n_{gg} of 1.45 at the wavelength λ of 1.55 μm. Moreover, the injection waveguide 11 in this case has a constant thickness e_{c} that is equal to 220 nm. The list of these physical parameters Pp_{gi} will be supplemented by the longitudinal variation pᵣₗ(x) of the depth pᵣₗ of the periodic indentations of the lateral diffraction grating, which affect the minimum width w_{gi,min} of the injection waveguide 11, which is determined hereafter.

The structural configuration Cs_{ref} also comprises the values of the physical parameters Ppᵣₗ of the lateral diffraction grating 12 that define the optical diffraction properties of the optical mode by the lateral diffraction grating 12. Thus, the physical parameters Ppᵣₗ can comprise the refractive index n_{gi} of the injection waveguide 11, the refractive index n_{gg} of the cladding, in this case equal to 1.45 for SiO₂, the angle of inclination β of the hypotenuse, in this case equal to 30°. The list of these physical parameters Ppᵣₗ will be supplemented by the longitudinal variation Λᵣ(x) of the pitch Λᵣ of the lateral diffraction grating 12, which will be determined hereafter.

During a step 20, a longitudinal variation pᵣₗ=p(x) of the depth pᵣₗ of the indentations of the lateral diffraction grating 12 is defined such that the longitudinal variation of the extraction rate αᵣₗ(x) results in a far-field emission profile Sᵣₗ(x) that is equal to the target emission profile S_{rl,c}(x), taking into account the reference structural configuration Cs_{ref}, and for a pitch Λᵣₗ that in this case is defined by the triangular shape of the indentations. More specifically, the indentations follow one another without any spacing along the longitudinal axis X between the end of the hypotenuse of a triangle and the end of the base oriented along the Y axis of the adjacent triangle. It should be noted that the angle of inclination β remains constant from one indentation to the next and is equal to 30°.

FIG. 7A illustrates an example of the function p of the longitudinal variation pᵣₗ=p(x) of the depth pᵣₗ of the indentations. In this example, the function p is a function of the following type: pᵣₗ(x)=p_{rl,max}×exp(−x²/2σ²), where p_{rl,max} is a predefined maximum value, in this case 300 nm, of the depth of the indentations, and where σ is the Gaussian variance of the target emission profile S_{rl,x}(x).

During a step 30, an evolution of the emission angle φᵣₗ is determined as a function of the pitch Λᵣₗ for various values of the depth pᵣₗ, and given the reference structural configuration Cs_{ref}. FIG. 7B illustrates an example of such an evolution. The pitch varies within a range that in this case extends from 650 to 750 nm, and several FDTD simulations are carried out for depths pᵣₗ equal to 50 nm, 100 nm, etc., up to the maximum value p_{rl,max} of 300 nm. A plurality of curves is determined, one per value of the depth pᵣₗ, passing through the relevant points.

The evolution Λᵣₗ=h(pᵣₗ) is then deduced between the pitch Λᵣₗ and the depth pᵣₗ, for which the emission angle φᵣₗ is equal to the target angle φ_{rl,c} of 5°. FIG. 7C illustrates an example of such an evolution, where the function h in this case is a power function. This curve passes through the points originating from FIG. 7B. Finally, by knowing the longitudinal variation pᵣₗ=p(x) and the relationship Λᵣₗ=h(pᵣₗ), it is possible to determine the longitudinal variation Λᵣₗ=q(x) of the pitch Λᵣₗ of the lateral diffraction grating 12.

Finally, during a step 40, guiding structures 10 for the optical antennas 7 are obtained that all have the same structural configuration Cs_{ref}, with said structural configuration therefore being supplemented by the longitudinal variation pᵣₗ=p(x) of the depth pᵣₗ of the injection waveguide and by the longitudinal variation Λᵣₗ=q(x) of the pitch of the lateral diffraction grating that have just been determined. The guiding structures 10 of the optical antennas 7 then can be manufactured.

It should be noted that this example also applies to the lateral diffraction gratings 12 of the type illustrated in FIG. 4C, in which they are formed by pads located at a distance on one side and/or on the other side of the injection waveguide 11. In this case, by way of an example, the method can determine the longitudinal variation w_{gi}=p(x) of the width w_{gi} of the injection waveguide 11 and the longitudinal variation Λᵣₗ=q(x) of the pitch of the lateral diffraction grating 12. Other physical parameters can vary, such as the fill factor, the dimensions of the pads, etc.

It should be noted that the guiding structure 30 also can be apodized so that the emission profile Sᵣᵥ(y) is equal to a target profile S_{rv,c}(y) and oriented at a target emission angle θ_{rv,c} that is constant along the longitudinal axis A_{L}. A method similar to that described above can be used. Parameters such as the pitch Λᵣᵥ of the vertical diffraction grating 32, and either one of the dimensions of the periodic structures 33, or even the fill factor, thus can have a longitudinal variation along the longitudinal axis A_{L}. In this respect, FIG. 6B is a schematic and partial cross-section of a guiding structure 30, in which the vertical diffraction grating 32 has a pitch Λᵣᵥ that varies longitudinally according to a predefined function. The length lᵣᵥ of the indentations in this case can have a longitudinal variation according to a predefined function. Thus, the longitudinal variation of the length lᵣᵥ (and therefore of the fill factor) according to a predefined function allows the desired emission profile to be obtained, and the longitudinal variation of the pitch Λᵣᵥ according to another predefined function allows the emission angle θᵣᵥ to be kept constant and equal to the target value (thus compensating for the variation in the effective index induced by that of the length lᵣᵥ).

Thus, the dimensioning and manufacturing method allows an apodized guiding structure 10 to be produced, i.e. which has longitudinal variations of the width w_{gi} of the injection waveguide 11 and of the pitch Λᵣₗ of the lateral diffraction grating 12 over at least part of the length of the guiding structure 10 of the optical antenna 7, so that the extracted light radiation has the desired far-field emission profile oriented at the desired emission angle. The method also can be applied to the guiding structure 30.

Particular embodiments have been described above. Various alternative embodiments and modifications will become apparent to a person skilled in the art.

1. An optoelectronic emitter with a phased-array antenna, comprising:
a splitter, intended to be coupled to a laser source;
a plurality of waveguides, called injection waveguides, coupled to the splitter and extending along a longitudinal axis in a main plane, forming the arms of the optoelectronic emitter;
a plurality of phase shifters and of optical antennas disposed in the arms, each optical antenna comprising:
the injection waveguide;
a guiding structure, called vertical emission guiding structure, intended to receive an optical mode originating from the injection waveguide, and formed by:
a waveguide, called emission waveguide, that is wider than the injection waveguide;
a vertical diffraction grating, coupled to the emission waveguide and adapted to extract to free space an optical mode flowing through the emission waveguide;
characterized in that each optical antenna comprises:
a guiding structure, called horizontal emission guiding structure, formed by:
the injection waveguide;
a lateral diffraction grating, coupled to the injection waveguide and adapted to extract, in the main plane and toward the emission waveguide, an optical mode flowing through the injection waveguide.

2. The optoelectronic emitter as claimed in claim 1, comprising a coupling structure formed by a graded index medium, located between the horizontal emission guiding structure and the vertical emission guiding structure, and adapted to provide optical coupling between the lateral diffraction grating and the emission waveguide.

3. The optoelectronic emitter as claimed in claim 2, wherein the coupling structure comprises an array of elementary couplers laterally arranged facing the lateral diffraction grating, and has transverse dimensions smaller than a main wavelength of the optical mode emitted by the laser source; or is formed by a medium with a first refractive index containing openings with transverse dimensions that are smaller than a main wavelength of the optical mode emitted by the laser source and filled with a medium with a second refractive index lower than the first index.

4. The optoelectronic emitter as claimed in claim 2, wherein the length of the coupling structure is less than or equal to its total width.

5. The optoelectronic emitter as claimed in claim 2, wherein the emission waveguide and the vertical diffraction grating respectively have widths that are at least equal to a total width of the coupling structure.

6. The optoelectronic emitter as claimed in claim 1, wherein the optical antennas are periodically arranged with a pitch λ_{a,y} along an axis orthogonal to the longitudinal axis of the injection waveguides, with the vertical diffraction grating having a total length, called extraction length l_{tot,rv}, that is greater than or equal to 50% or 80% of the pitch Λ_{a,y}.

7. The optoelectronic emitter as claimed in claim 1, wherein the optical antennas are periodically arranged with a pitch Λ_{a,x} along the longitudinal axis of the injection waveguides, with the vertical diffraction grating having a width w_{tot,rv} that is greater than or equal to 50% or 80% of the pitch Λ_{a,x}.

8. The optoelectronic emitter as claimed in claim 1, wherein the lateral diffraction grating is adapted to extract the optical mode at an emission angle φᵣₗ relative to an axis located in the main plane and orthogonal to the longitudinal axis of the injection waveguide, with the vertical emission guiding structure being arranged along a longitudinal axis parallel to the emission angle φᵣₗ.

9. The optoelectronic emitter as claimed in claim 1, wherein the length, called extraction length l_{tot,rl}, of the lateral diffraction grating is greater than a width of the injection waveguide, and wherein the width of the emission waveguide is at least equal to the extraction length l_{tot,rl} of the lateral diffraction grating.

10. The optoelectronic emitter as claimed in claim 1, wherein the width of the injection waveguide is less than or equal to 1 μm, and the widths of the emission waveguide and of the vertical diffraction grating are respectively greater than or equal to 10 μm.

11. The optoelectronic emitter as claimed in claim 1, wherein the total length, called total extraction length l_{tot,rv}, of the vertical diffraction grating is greater than or equal to 10 μm.

12. The optoelectronic emitter as claimed in claim 1, wherein the lateral diffraction grating is formed by periodic indentations produced in the injection waveguide; or is formed by periodic pads located at a distance from the injection waveguide.

13. The optoelectronic emitter as claimed in claim 1, wherein the injection waveguide has a longitudinal variation of at least one parameter representing its width according to a predefined function p, and the lateral diffraction grating has a longitudinal variation of a pitch Λᵣₗ of an arrangement of periodic structures according to a predefined function q, with the functions p and q being predefined as a function of a predefined far-field target emission profile S_{rl,c}(x) of light radiation extracted by the lateral diffraction grating and of a predefined target emission angle φ_{rl,c}.

14. The optoelectronic emitter as claimed in claim 1, wherein the vertical diffraction grating has a longitudinal variation of at least one dimensional parameter of periodic structures according to a function that is predefined as a function of a predefined far-field target emission profile Srv_{,c}(x) of light radiation extracted by the vertical diffraction grating and of a predefined target emission angle φ_{rv,c}.

15. The optoelectronic emitter as claimed in claim 1, comprising an SOI-type photonic chip containing the lateral emission guiding structure, and the vertical emission guiding structure.
